(19) United States
(12) Patent Application Publication
(10) Pub. No.: US 2005/0254423 A1
(43) Pub. Date: Nov. 17, 2005

(54) Rate shaper algorithm

(75) Inventor: Gerald Berghoff, Dusseldorf (DE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/921,834

(22) Filed: Aug. 20, 2004

(30) Foreign Application Priority Data
May 12, 2004 (EP) 04011299.7

(51) Int. Cl. H04L 12/26; H04J 3/14

(52) U.S. Cl. 370/230.1; 370/252

(57) ABSTRACT

The invention proposes a rate shaping device, comprising a packet timing determining means (131) for determining departure times of packets to be sent, and a packet sending means (132) for sending the packets according to the determined departure times, wherein the packet timing determining means is adapted to determine the departure times by taking into account a desired data rate and a priority of the packets. The invention also proposes a corresponding method and a network system in which in a second network element the packets are fragmented according to the priority.

### BACKGROUND OF THE INVENTION

1. Field of the Invention

The invention relates to a rate shaping device, a corresponding method and a network system comprising a rate shaping device and a packet fragmentation device.

2. Description of the Related Art

Today's packet-oriented networks are required to provide service differentiation for applications with different Quality of Service (QoS) needs. Packet-oriented networks in this context are IP (Internet Protocol) and MPLS (Multiprotocol Label Switching) networks, for example. IP and MPLS are in the present description referred to as “Layer 3”, as only the packet-oriented nature of these protocols is of interest. QoS mechanisms on layer 3 (like DiffServ (Differentiated Services)) involve prioritization and dropping of packets, in order to achieve the desired behavior in terms of QoS parameters like delay, delay variation and loss.

To further reduce delay and delay variation for high priority (urgent) packets, mechanisms on layer 2 like Multi-Class extensions for Multi-Link PPP (MCMP; PPP=Point-to-Point Protocol) or Differentiated UBR for ATM (Diff-UBR; UBR=Unspecified Bit Rate, ATM=Asynchronous Transfer Mode) can additionally be employed. These layer 2 mechanisms are limited to the layer 2 link between two layer 3 nodes (IP routers or MPLS LSRs (Label Switching Routers)). Their operation is transparent to the IP or MPLS layer of these adjacent nodes.

ATM Forum document: Technical Committee “Addendum to TM 4.1: Differentiated UBR”, af-tm-0149.000, July 2000, describes differentiated UBR which is one method for transporting IP diffServ over ATM.

MCMP and Diff-UBR, both involving fragmentation and the possibility to suspend transmission of one packet in favour of another packet, are particularly of interest on low-bandwidth links like E1 (European Digital Signal Level 1) or T1 (Transmission System 1), on which the transmission time of a packet may not be negligible for the application. For example, the transmission of a 1500 Byte packet on an E1 link takes roughly 6 ms, during which the link is not available for other packets of possibly higher priority; this may be too much for real-time applications.

Thus, there is a problem that packets with high priorities such as packets of real-time applications may be delayed.

This problem is in particular serious when a rate shaper is applied which adjust the data rate of a data stream consisting of packets by inserting time gaps between subsequent packets according to the desired data rate. Such a rate shaper is disclosed in U.S. Pat. No. 5,460,389, for example.

In this situation, waiting the calculated time until the gap is over before transmitting the high priority packet will delay the high priority packet unnecessary long (maybe even too much), especially for low capacity layer 2 functions where the calculated gap can be long for big packets. That is, the prioritised transmission of high priority packets by the layer 2 function cannot be sufficiently supported and, hence, the benefit of such a mechanism can not be exploited.

### SUMMARY OF THE INVENTION

Hence, it is an object of the invention to ensure a faster delivery of packets with high priority by applying a suitable rate shaper algorithm.

This object is solved by a rate shaping device comprising a packet timing determining means for determining departure times of packets to be sent, and a packet sending means for sending the packets according to the determined departure time, wherein the packet timing determining means is adapted to determine the departure times by taking into account desired data rate and priorities of the packets.

Alternatively, this object is solved by a method for setting a data rate of packets comprising the steps of determining departure times of packets to be sent, and sending the packets according to the determined departure time, wherein in the packet timing determining step the departure time is determined by taking into account a desired data rate and priority of a packet.

Thus, according to the invention, a rate shaper algorithm is proposed that calculates packet departure times, and, thus, time intervals between packet departures, not only depending on packet sizes and data rate, but also taking into account packet priorities. It is able to suspend the transmission of low priority packets in favour of high priority packets while still respecting the maximum transmission rate.

Hence, a faster delivery of packets having a higher priority is ensured.

This allows to take advantage of layer 2 QoS mechanisms that are based on fragmentation.

Moreover, the algorithm according to the present invention is especially beneficial to minimise the delay of high priority, delay sensitive packets on low capacity links. Namely, on low capacity links the overall transmission time for big packets is long. If the algorithm is not used, a big low priority packet might occupy the transmission link for a long time thus leading to long delays for high priority, delay sensitive packets waiting for transmission.

The invention also proposes a network system comprising a first network element comprising a rate shaping device as defined above, a second network element and a link for connecting the first network element and the second network element, wherein the second network element comprises a fragmentation means for fragmenting the packets received from the first network element, wherein the fragmentation means is adapted to detect the priorities of the received packets and to fragment the packets and to arrange the packet fragments in timely order by taking into account the priorities of the packets.

Further advantageous developments are set out in the dependent claims.

### BRIEF DESCRIPTION OF THE DRAWINGS

The invention is described by referring to the enclosed drawings, in which:

FIG. 1 shows a basic structure of a layer 3 block and a layer 2 block, where a preferred embodiment of the present invention can be applied,

FIG. 2 shows a basic structure of a rate shaper according to the preferred embodiment of the present invention,

FIG. 3 shows a flow chart illustrating a basic procedure according to the preferred embodiment of the present invention, and

FIGS. 4A and 4B show timing charts for illustrating the rate limiting algorithm according to the preferred embodiment of the present invention.

### DETAILED DESCRIPTION OF THE PREFERRED EMBODIMENT

In the following, a preferred embodiment of the present invention is described by referring to the attached drawings.

First, the general problem underlying the present invention is described in detail in the following.

An IP router or MPLS label switching router may implement QoS mechanisms on layer 3 (e.g. following the Differentiated Services (Diffserv) architecture) as well as on layer 2 (e.g. MCMP or Diff-UBR). DiffServ on layer 3 works on complete packets and consists of packet scheduling according to priorities and potentially dropping for congestion avoidance. Various algorithms for strict priority scheduling, weighted scheduling and congestion avoidance are in use.

MCMP and Diff-UBR on layer 2 perform fragmentation of layer 3 packets in layer 2 fragments or cells and consist of fragment scheduling according to priorities. Also here, strict priority scheduling or a weighted scheduling mechanism can be applied. The purpose is to interleave fragments belonging to a packet of high priority within fragments of a packet with lower priority, resulting in a changed packet order after re-assembly at the receiving end. It is noted that, as the packets whose order is changed are of different priorities, this reordering is not harmful, but it is, quite the contrary, just the objective of this operation. This operation is of particular interest on low-speed links (like E1, T1).

In the layer 2 operation, fragment loss (leading to packet loss) due to over-subscription of an interface (exceeding the data rate of a transmit interface) must be avoided. The fragmentation on layer 2 and the fragment scheduling take place between two adjacent layer 3 nodes and are completely transparent to layer 3 (fragmentation is done by the sending node after the routing/forwarding/switching decision was taken, and reassembly of fragments to packets is done by the receiving node before routing/forwarding/switching the packet).

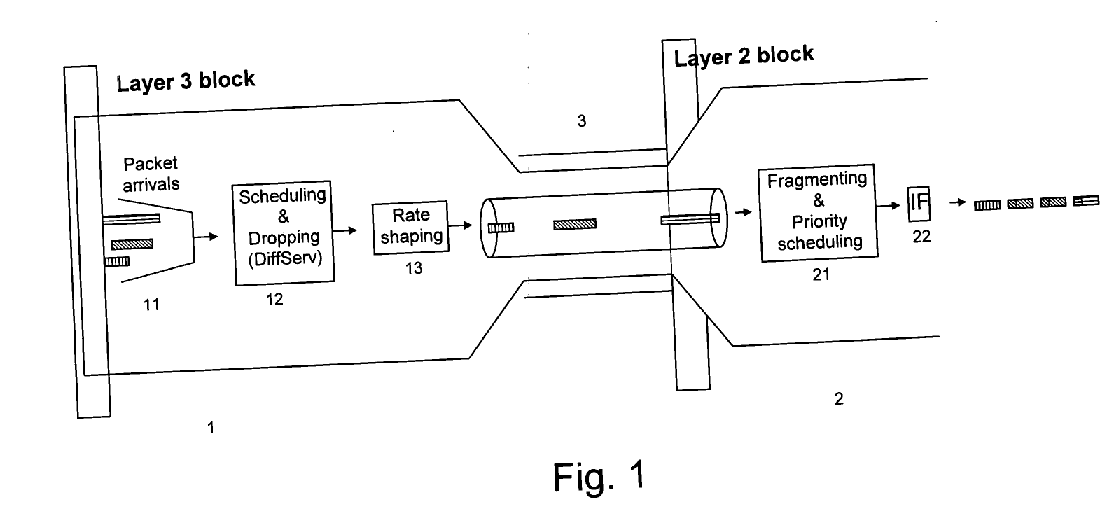

The algorithm according to the preferred embodiment of the present invention applies to the following situation which is shown in FIG. 1. FIG. 1 shows a layer 3 block denoted by reference numeral 1 and a layer 2 block denoted by reference numeral 2. The packets arriving in block 1 (see FIG. 1) are forwarded to a scheduling & dropping block 12, which is a part of the DiffServ function, (in the following referred to as scheduler/dropper), which forwards the packets to a rate shaper (also referred to as rate limiter, rate shaping or limiting means). The layer 3 block and the layer 2 block are connected by an internal interface 3 which has a high capacity compared to the network interface 22. The layer 2 block comprises a fragmenting & priority scheduling block 21 (also referred to as fragmenter/scheduler) which performs the fragmentation of the packets received by the layer 2 block. The fragments are then forwarded to a network interface (IF) 22 which transmits the fragmented packets via a network. That is, the internal interface 3 transmits whole packets, whereas the network interface 22 transmits fragments of packets. It is noted that the fragmented packets are indicated in the drawings by having a darker “header”.

The structure and operation according to the preferred embodiment of the present invention is described in the following in more detail.

The scheduler/dropper for layer 3 (DiffServ) and the fragmenter/scheduler for layer 2 (MCMP, Diff-UBR) are implemented in separate functional blocks of the router (for example, they may be implemented on a central unit (layer 3) and one or more line cards (layer 2)), for example. The internal interface 3 that connects these two blocks is of much higher capacity (data transmission speed) than the external interface 22 on which packets/fragments are finally transmitted.

In this type of architecture, the layer 3 block is required to limit the data rate on the interface to the layer 2 block to a value that does not exceed the maximum capacity of the layer 2 function (e.g., layer 2 belonging interface capacity of the external interface), in order to avoid packet loss in the layer 2 block. The reason for this is that packet dropping decisions should be done at only one single place and layer, and this is the layer 3 block that may process packets according to the Differentiated Services or Integrated Services architectures. Limiting the data rate on the interface between the layer 3 and the layer 2 block is called “rate shaping” in this description.

Rate shaping in its basic form is done by inserting time intervals between subsequent packets. The duration of a time interval before a new packet is transmitted is calculated with respect to the size (length) of the previous packet and the interface rate. This approach avoids packet/fragment loss in the layer 2 block. However, when this approach is used without taking the special feature of the present invention into account, i.e., when the time interval or time gap is calculated without considering the priority of the packet, this approach has the drawback that the layer 2 block only has one single packet to process, at any time. A new packet is received from layer 3 just when the transmission of the previous packet is finished. There will never be two packets in that functional block, which inhibits the layer 2 block from performing prioritization and interleaving of fragments belonging to different packets. So, the layer 2 prioritisation would be useless.

The algorithm according to the preferred embodiment of the present invention solves this problem. It enables prioritization on layer 2, hence, allows to exploit layer 2 QoS mechanisms, while, at the same time, respecting the maximum transmit rate of the external interface.

One way to avoid the above stated problem is not to separate the layer 3 and layer 2 QoS functionality, but to implement both in one functional block e.g. by a network processor or ASIC. However, a drawback of this solution is that it puts strong restrictions on the internal router architecture (the separation of functional blocks may be very attractive from technical, commercial and strategic point of view).

Hence, according to the preferred embodiment of the present invention, the timing of sending subsequent packets, i.e., the time gap between subsequent packets is calculated not only based on the size of the packets and the interface rate, but also based on the priority of the packet concerned.

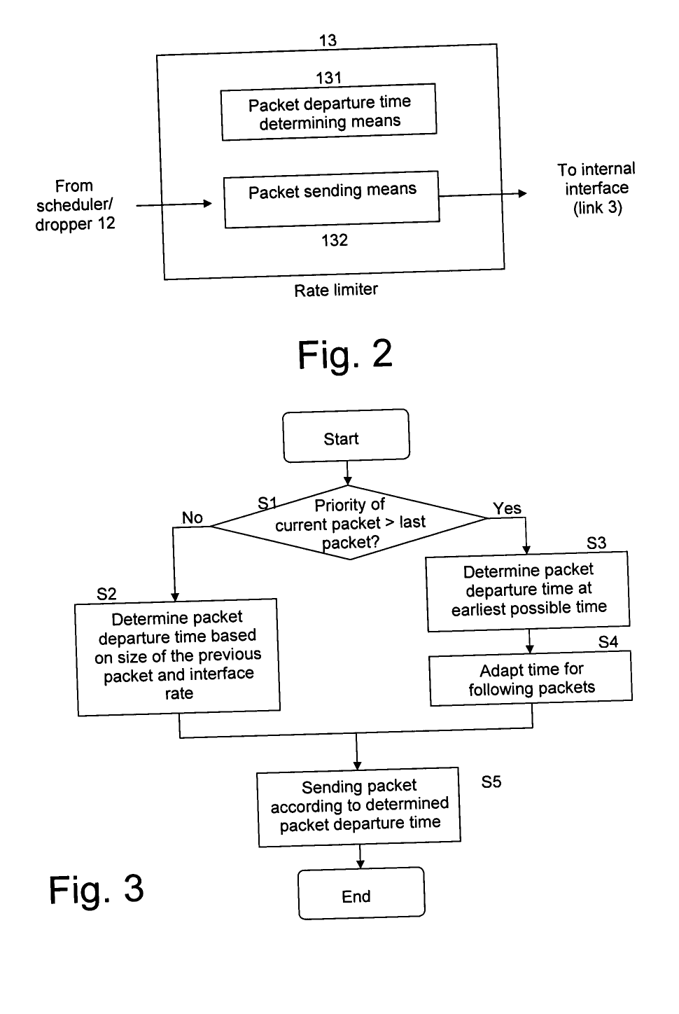

The basic structure of the rate shaper 13 (or rate limiter) according to the preferred embodiment of the present invention is illustrated in FIG. 2. The rate shaper 13 comprises a rate calculating means 131 as an example for a packet departure time determining means in order to determine the departure time of the corresponding packet. As mentioned above, this is effected by taking into account a desired data rate, the packet size and the priorities of the current and previous packets. Furthermore, the rate shaper comprises a packet sending means 132 for sending the packets according to the determined departure time. For example the packet sending means may comprise a buffer in which the packets a stored temporarily and from which they are sent according to the determined departure times.

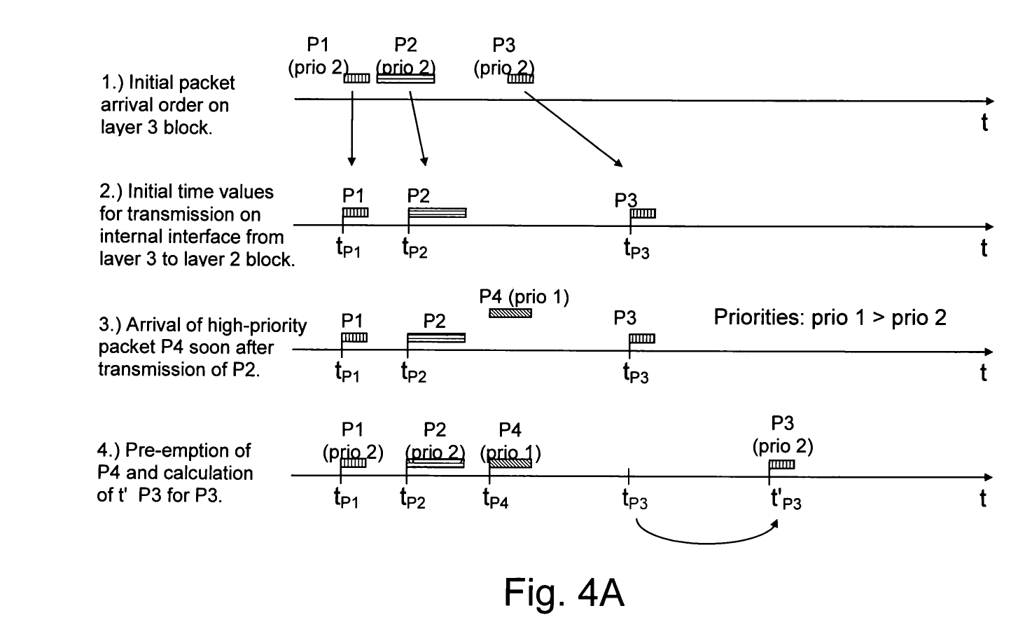

FIG. 3 illustrates the basic operation according to the preferred embodiment of the present invention.

The procedure illustrated in FIG. 3 is performed each time a packet is received. In step S1, the priority of a received packet (i.e., the current packet) is detected and evaluated with respect to the priority of the previous packet (i.e., the, last packet). That is, it is determined whether the priority of the current packet is greater than that of the last packet. If the priority is not greater (i.e., lower or equal), the departure time of the packet to be sent is determined in step S2 based on size of the previous packet and the interface rate, and in step S5, the packet is sent according to the determined departure time.

If in step S1 it is found that the priority of the current packet is greater, the departure time of the current packet is determined on the earliest possible time in step S3, and in step S4 the time for the following packets is adapted. After this, the packet is sent in step S5 according to the determined packet departure time.

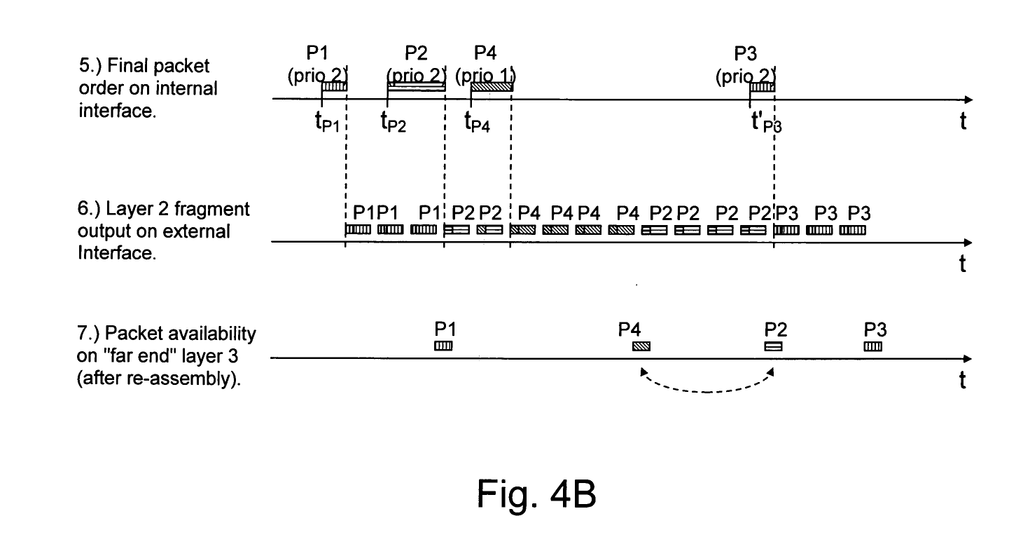

In particular, the determination of the packet departure time is performed based on the priority detected in step S1. That is, in case the packet has a lower priority (i.e., “no” in step S1), the packet departure time is determined based on the size of the previous packet and the desired rate (e.g., an interface rate for a network via which the packets are to be sent), as indicated in step S2. On the other hand, when the packet has a higher priority (i.e., “yes” in step S1), the departure time is determined to a time point which is as soon as possible. For example, this could mean that a packet with higher priority is sent immediately after sending a packet with a lower priority, and this advanced sending is taken into account for the next packet. Alternatively, this could also mean that a packet with lower priority received earlier than the packet with higher priority is actually sent later, as will be described in the following by referring to FIG. 4 in detail. That is, for packets of a lower priority, step S5 may be carried out later than the corresponding step for a subsequently received packet of a higher priority.

The operation according to the preferred embodiment is described in the following in more detail by referring to FIG. 1 and to FIGS. 4A and 4B.

In order to perform differentiated treatment of fragments belonging to packets of different priorities, the layer 2 considers the priority of a packet. This priority of a packet is known by the layer 3, and it is signalled to the layer 2 by adding a proprietary information field to the packet or using a suitable field depending on the kind of protocol and encapsulation that is used between the layer 3 and the layer 2 block. This may be e.g. the priority bits in the VLAN-Ethernet (VLAN=Virtual Local Area Network) header. This approach is much more efficient than having the layer 2 block perform an inspection of multiple header fields of the packet to determine its priority.

FIGS. 4A and 4B illustrate the algorithm according to the preferred embodiment of the present invention. In this example, only two priorities (prio 1 and prio 2) of the packets are shown. However, it is noted that an arbitrary number of priorities is also possible.
1.) In the initial situation, only packets with low priority (prio 2) are present in the layer 3 block.
2.) If t_P1 is the point in time when packet 1 (P1) is sent, then t_P2 for P2 is calculated according to the size of P1 (Time to wait until next packet is sent=size of current packet/interface rate). When P2 is sent, t_P3 for P3 is calculated.
3.) During transmission of P2 from layer 3 block to layer 2 block, a packet P4 with higher priority (prio 1, wherein prio 1>prio 2) than P2 is received by the layer 3 block and is, according to its high priority, to be sent out earlier than the existing low priority packets.
4.) The departure time t_P4 for this packet is not calculated according to the size of P2, but it is sent to the layer 2 block as soon as possible, i.e., right after P2. That is, the departure time of packet P4 is even earlier than the originally calculated departure time t_p3 of packet P3.
   The departure time for P3, the next packet with prio 2, needs to be updated taking into account the packet size of P4. t′_P3 is calculated according to t′_P3−t_P2=size of (P2+P4)/interface rate The time by which a packet with high priority (prio 1) is advanced compared to the “normal” departure time (by sending it right after a packet of low priority) is added to the interval for the next packet of lower priority (prio 2).
   Note: if P3 was a packet with prio 1, or if during transmission of P4 another packet with prio 1 appeared, the time interval of this packet would be “size of P4/interface rate”, i.e. the “normal” way of calculating the interval between packets would be used. This ensures that also with a plurality of packets having a higher priority the desired data rate is not exceeded.
5.) The final order of packet transmission from layer 3 block to layer 2 block is shown.
6.) In the layer 2 block, the packets are fragmented according to MCMP or Diff-UBR procedures (the additional encapsulation performed by these protocols is not of interest in this context). These fragments are then transmitted over the physical interface (at the interface rate). As P4 is sent from layer 3 block to layer 2 block right after P2, the layer 2 block can suspend the transmission of P2-fragments and transmit the P4-fragments instead. After that, transmission of P2-fragments is resumed.
7.) Finally, after re-assembling the packet fragments at the far end (receiving end, not shown in FIG. 1), complete packets are available. Due to the suspension of the transmission of fragments of P2 in favour of fragments of P4, the packet order of P2 and P4 has changed after re-assembly. That is, the packet with higher priority (P4) is available earlier than the packet with lower priority (P2), which is in contrast to the initial arrival order on the layer 3 block, and which is the purpose of layer 2 prioritization.
   Note that without the immediate transmission of the high-priority packet in step 4.), the resulting re-ordering of packets would not have taken place, and layer 2 fragmentation and priority scheduling of fragments would be useless.

This example shows that the proposed rate shaper algorithm does not follow the approach of calculating strict time intervals between the transmission of packets. Instead, it determines the interval taking into account the priorities of the current and the previous packets. If a packet has a higher priority than the previous, it can be sent right after the previous. Then the layer 2 block can suspend the transmission of fragments of lower priority in favor of fragments of higher priority. In the layer 3 block, the departure times for the following packets need to be updated.

It is noted that the terms “time gap” or “time interval” and the term “packet departure time” are equivalent. Namely, the term “time interval” refers to the time period between a packet departure time and a subsequent packet departing time, and the term “time gap” refers to that period which starts after the end of a previous packet to the packet departure time of the subsequent packet.

The calculation of the departure times is also illustrated by the following pseudo-code for the case of 2 different priorities. It is noted that this code follows the C language in general. That is, {and} enclose a sub-procedure, T1—denotes a decrementing of a timer T1, /* and */enclose comments and the like. First, two timers are defined:
T1: Decrementing timer in layer 3 block for high-priority queue in layer 2 block. It counts the time that is needed for sending a high-priority packet over the external transmission interface. When T1 has decreased to 0, the next high-priority packet (HPP) may be sent.
T2: Decrementing timer in layer 3 block for low-priority queue in layer 2 block. It counts. the time that is needed for sending a low-priority packet over the external transmission interface. When T2 has decreased to 0, the next low-priority packet (LPP) may be sent.
   Calculation of T2 should take into account pre-emption of low-prio packets by high-prio packets. When pre-emption takes place, the value of T2 is incremented by the time that the pre-empting HPP needs to be transmitted on the external interface.

Note that always T1<=T2!

```
T1 = 0;
T2 = 0;
for every time step (timing signal provided by background clock)
{
  if T1 = 0
    if HPP is available to be sent to layer 2 block
    {
      initiate transmission of HPP to layer 2 block;
      t_HPP = (size(HPP) + header) / rate_IF; /* or use look-up table */
      T1 = t_HPP;
      T2 = T2 + t_HPP;
    }
  if T2 = 0
    if LPP is available to be sent to layer 2 block
    {
      initiate transmission of LPP to layer 2 block;
      t_LPP = (size(LPP) + header) / rate_IF; /* or use look-up table */
      T2 = t_LPP;
    }
  if T1 > 0
    T1--;
  if T2 > 0
    T2--;
}
```

It is noted that in the above example t_HPP corresponds to t_P4 in FIG. 4 (for packet P4 having the priority prio 1), and that t_LPP corresponds to t′_P3 in FIG. 4 (for packet P3 having the priority prio 2), for example. The value rate_IF is the network transfer rate by which the interface (22 in FIG. 1) can actually transmit data via the network.

Thus, according to the preferred embodiment of the invention, a rate shaper algorithm is proposed that calculates packet departure times, and, thus, time intervals between packet departures, not only depending on packet sizes and data rate, but also taking into account packet priorities. It allows to suspend transmission of low priority packets in favour of high priority packets while still respecting the maximum transmission rate.

This allows to take advantage of layer 2 QoS mechanisms that are based on fragmentation.

An advantage of this solution is the possibility to implement layer 3 and layer 2 functions in separate blocks, and to use a simple interface between them. This allows a high degree of freedom in the architectural design of packet-forwarding network elements, which may lead to technically, commercially and strategically attractive products.

It is noted that the invention is not limited to the embodiments described above, which should be considered as illustrative and not limiting. Thus, many variations of the embodiments are possible.

For example, the embodiment described above employs two levels of priorities. However, this scheme can be easily extended in a straight-forward way to more levels of priorities. Packets of the lowest priority are never advanced and interleaved, packets of the next-higher priority level can be advanced and their fragments can be interleaved in fragments of the lowest priority (but not in fragments of packets of the same or higher priority), and so on. Packets of the highest priority can always be advanced (except if the previous packet was also of highest priority).

Furthermore, the above embodiment is directed to a Layer 3/Layer 2 structure. However, the invention is not limited to this architecture, but can be applied whenever a first network element supplies data to a second network element with a higher data rate as the rate which the second network is capable to process. In particular, the invention is not limited to a network interface of the second network element (the network transfer rate of which actually determines the desired data rate to be set in the rate shaper), but also other forms of data processing means are possible.

Moreover, it is noted that according to the above-described embodiment, the rate shaping device and method determine the departure timings of packets by taking into account priority and size of the packets and the desired data rate. Note, in case of a constant packet size, the step of determining the packet departure times is simplified as the packet size can be replaced by a constant factor in the calculations.

1. A rate shaping device, comprising:
a packet timing determining means for determining departure times of packets to be sent; and
a packet sending means for sending the packets according to the determined departure time,
wherein the packet timing determining means is configured to determine the departure times by taking into account desired data rate and priorities of the packets.

2. The rate shaping device according to claim 1, wherein the packet timing determining means is configured to determine the departure times by also taking into account the size of the packets.

3. The rate shaping device according to claim 1, wherein the packet timing determining means is configured to determine the departure time of a packet of a higher priority received after a packet of a lower priority such that the departure time of the packet of the higher priority is set earlier than the departure time of the packet of the lower priority.

4. The rate shaping device according to claim 1, wherein the packet timing determining means is configured to set the departure time of a packet of a higher priority such that a gap between a previously sent packet of lower priority and the departure time of the packet of the higher priority is zero or substantially zero.

5. The rate shaping device according to claim 4, wherein the packet timing determining means is configured to adapt a departure timing for a packet of high priority following a packet of the same high priority according to the desired data rate.

6. The rate shaping device according to claim 1, wherein the packet timing determining means is configured to determine a departure time of a packet of lower priority to be sent after a packet with higher priority by also taking into account the length of the packet with the higher priority plus the last preceding low priority packet and the desired data rate.

7. The rate shaping device according to claim 1, wherein two priorities are defined for the packets.

8. The rate shaping device according to claim 1, wherein the rate determining means is configured to determine the departure time based on a calculation or is configured to determine the departure time by referring to a look-up table.

9. A network system comprising:
a first network element comprising a rate shaping device, the rate shaping device comprising a packet timing determining means for determining departure times of packets to be sent, and a packet sending means for sending the packets according to the determined departure time, wherein the packet timing determining means is configured to determine the departure times by taking into account desired data rate and priorities of the packets;
a second network element; and
a link for connecting the first network element and the second network element,
wherein the second network element comprises a fragmentation means for fragmenting the packets received from the first network element and, wherein
the fragmentation means is configured to detect the priorities of the received packets and to fragment the packets and to arrange the packet fragments in timely order by taking into account the priorities of the packets.

10. The network system according to claim 9, further comprising a network interface for transmitting the fragmented packets via a network, wherein the desired data rate is set based on interface rate achievable by the network interface.

11. The network system according to claim 9, wherein the first network element includes a layer 3 block and the second network element includes a layer 2 block.

12. A method for setting a data rate of packets comprising the steps of:
determining departure times of packets to be sent; and
sending the packets according to the determined departure time,
wherein in the packet timing determining step the departure time is determined by taking into account a desired data rate and priority of a packet.

13. The method according to claim 12, wherein the packet timing determining step further comprises determining the departure times by also taking into account the size of the packets.

14. The method according to claim 12, wherein the packet timing determining step further comprises determining the departure time of a packet of a higher priority received after a packet of a lower priority such that the departure time of the packet of the higher priority is set earlier than the departure time of the packet of the lower priority.

15. The method according to claim 12, wherein the packet timing determining step further comprises setting the departure time of a packet of a higher priority such that a gap between the previously sent packet and the departure time of the packet of the higher priority is zero or substantially zero.

16. The method according to claim 15, wherein the packet timing determining step further comprises adapting a departure timing for a packet of high priority following the packet of the same high priority according to the desired data rate.

17. The method according to claim 12, wherein the packet timing determining step further comprises determining a departure time of a packet with lower priority to be sent after a packet with higher priority by also taking into account the length of the packet with the higher priority plus the last preceding low priority packet and the desired data rate.

18. The method according to claim 12, comprising defining two priorities for the packets.

19. The method according to claim 12, wherein the rate determining step comprises determining the departure time based on a calculation, or determining the departure time by referring to a look-up table.

20. The method according to claim 12, further comprising the steps of:
fragmenting the received packets;
detecting the priorities of the received packets; and
arranging the packet fragments in timely order by taking into account the priorities of the packets.

21. The method according to claim 20, further comprising the step of:
transmitting the fragmented packets via a network by using a network interface, wherein the desired data rate is set based on interface rate achievable by the network interface.

22. The method according to claim 20, comprising the step of performing the packet departure time determining step in a layer 3 block, and the fragmenting step in a layer 2 block.

23. An apparatus for setting a data rate of packets, the apparatus comprising:
determining means for determining departure times of packets to be sent; and
sending means for sending the packets according to the determined departure time,
wherein in the determining means determines the departure time by taking into account a desired data rate and priority of a packet.
